(19) United States
(12) Patent Application Publication
(10) Pub. No.: US 2011/0307133 A1
(43) Pub. Date: Dec. 15, 2011

(54) SYSTEM FOR ADJUSTING GO-KART SPEED

(76) Inventor: DENNIS BRANDON, Brentwood, TN (US)

(21) Appl. No.: 13/158,104

(22) Filed: Jun. 10, 2011

Related U.S. Application Data
(60) Provisional application No. 61/353,269, filed on Jun. 10, 2010.

(51) Int. Cl. G06F 7/00; G06F 17/30

(52) U.S. Cl. 701/22; 235/375

(57) ABSTRACT

A system and related methods to automatically equalize acceleration rates and speeds of an electric go-kart based on the weight and other characteristics of the driver. Each kart is equipped with a transponder with a unique frequency that is controlled by a remote control transmitter via radio frequency (RF). The remote control transmitter is capable of changing the speed settings of the electric motor controller on each kart on the track before, after and during a race. Each driver is issued a “Driver's License” in the form of a card with a magnetic stripe that contains, but is not limited to, information on the driver's account balance, driver's race level, and the driver's weight. This information is read from the Driver's License card and used to adjust the speed and acceleration rate of the electric motor of the kart being driven by that participant. The card can be read at the Point-of-Sale (POS) (i.e., cashier, or check-in), or by a card reader on each individual kart.

This application claims benefit of and priority to U.S. Provisional Application No. 61/353,269, filed Jun. 10, 2010, by Dennis Brandon, and is entitled to that filing date for priority. The specification, figures and complete disclosure of U.S. Provisional Application No. 61/353,269 are incorporated herein by specific reference for all purposes.

### FIELD OF INVENTION

This invention relates to a system and method for adjusting go-kart speeds and acceleration rates based in part on driver weight and race level.

### BACKGROUND OF THE INVENTION

Go-kart or go-cart racing is a popular activity, both recreationally and commercially. A go-kart (or “kart”) is a small, four-wheeled vehicle, powered by an internal combustion or electric motor. Most seat a single driver, but some models can accommodate a passenger. Examples of go-karts and components are disclosed in U.S. Pat. No. 5,663,630; U.S. Pat. No. 6,170,596; and U.S. Pat. No. 7,000,727; all of which are incorporated herein by specific reference for all purposes.

In recreational or concession kart racing, participants typically rent a kart for a period of time to race on an indoor or outdoor track. Speeds can vary, depending on the track, type of racing, and the kart configuration. Some karts can go at speeds in excess of 50 mph. Many tracks offer competitive racing and leagues for registered participants.

Electric-powered karts are becoming increasingly popular, and possess several advantages over karts with gasoline-powered engines. Electrics karts require less maintenance, have low-end torque, and are generally emission free. Electric karts are the preferred karts for indoor tracks.

### SUMMARY OF INVENTION

In various embodiments, the present invention comprises a system and related methods to automatically equalize acceleration rates and speeds of an electric go-kart based on the weight and other characteristics of the driver.

In one exemplary embodiment, the system automatically programs the electric motor controller on a kart to various settings in order to equalize acceleration rates and speeds for different weight drivers. Each kart is equipped with a transponder with a unique frequency that is controlled by a remote control transmitter via radio frequency (RF). The remote control transmitter is capable of changing the speed settings, including the acceleration rate (or rate at which power or amperage is delivered to the motor), of the electric motor controller on each kart on the track before, after and during a race.

In one embodiment, the motor speed and acceleration rate for each kart is adjusted based on driver weight so that the actual acceleration rates and maximum speed of the karts in a race is comparable. In one embodiment, each driver is issued a “Driver's License” in the form of a card with a magnetic stripe that contains, but is not limited to, information on the driver's account balance, driver's race level, and the driver's weight. Other information unrelated to speed control also may be included on the Driver's License card.

Information, including the driver's weight, is read from the Driver's License card and used to adjust the speed and acceleration rate of the electric motor of the kart being driven by that participant. The card can be read at the Point-of-Sale (POS) (i.e., cashier, or check-in), or by a card reader on each individual kart. The “Normal Speed” is determined based on race level (e.g., novice, open or pro, although in other embodiments, there may be more than or fewer than three race levels). These speeds correlate to a calculated base motor speed necessary to achieve that speed, based upon the typical weight of a kart and an assumed standard driver weight. To achieve these maximum speeds with similar acceleration rates for a particular kart, the electric motor controller adjusts the base motor speed or the acceleration rate or both, based on the driver's actual weight.

In one embodiment, the point-of-sale (POS) and scheduling software utilize the remote RF system. When a customer checks in they will be assigned to a specific kart that, via the remote RF system, will have that kart electric motor controller programmed to a “Normal Speed” based, at least in part, on the driver's weight. The POS scheduling software also may assign a driver to a proper kart (i.e., one with an appropriate small, medium or large seat) based on weight information.

Alternatively, when the driver chooses or is assigned a particular kart, he or she can insert or swipe their driver's license card in a card reader or similar device on the kart, and the kart's electric motor controller will be programmed based on the driver's race level and weight information contained on the card. This method of programming allows greater flexibility, such as during team driving events.

In another alternative embodiment, the driver's weight information may be stored in a database (as opposed to a Driver's License card), and retrieved by the POS software when the driver checks in.

### DESCRIPTION OF THE DRAWINGS

FIG. 1 shows a flowchart of a system in accordance with an embodiment of the present invention.

### DETAILED DESCRIPTION OF EXEMPLARY EMBODIMENTS

In various embodiments, the present invention comprises a system and related methods to automatically equalize acceleration rates and speeds of an electric go-kart based on the weight and other characteristics of the driver. The technical components of an electric go-kart generally comprise an electrical motor, an electric motor controller, and the batteries, which provide a source of electrical power.

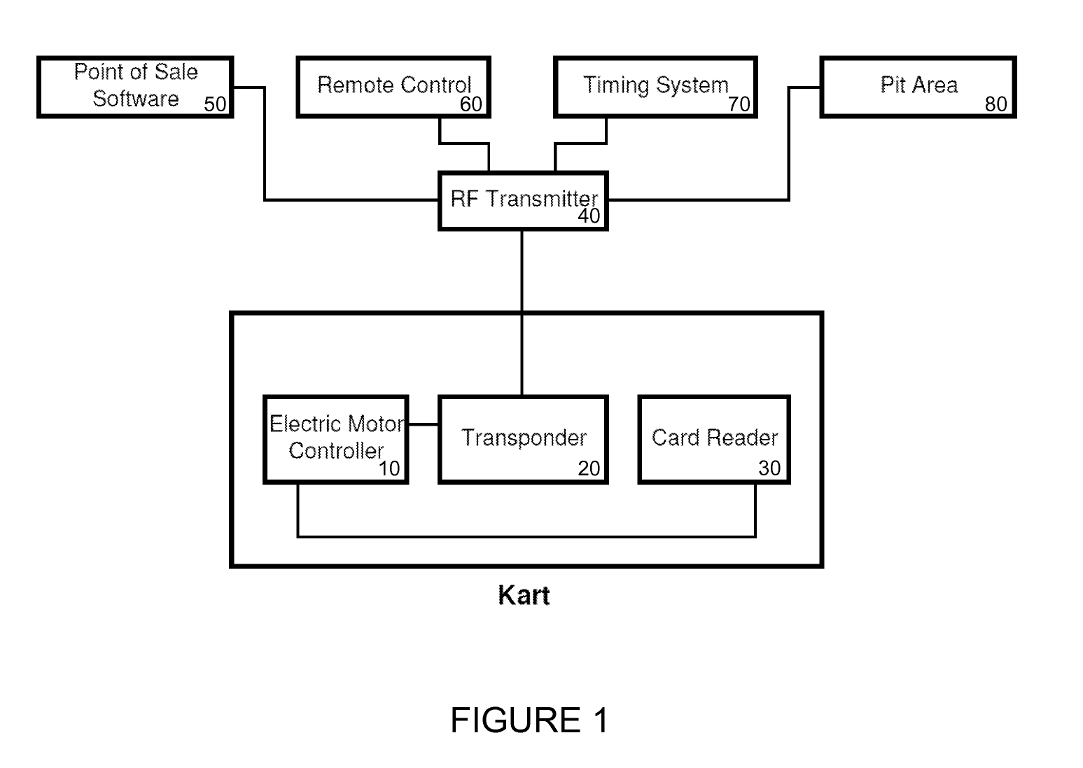

In one exemplary embodiment, as seen in FIG. 1, the system automatically programs the electric motor controller 10 on a kart to various settings in order to equalize acceleration rates and speeds for different weight drivers. Each kart is equipped with a transponder 20 with a unique frequency that is controlled by a remote control transmitter 40 via radio frequency (RF). The remote control transmitter is capable of changing the speed settings of the electric motor controller on each kart on the track before, after and during a race.

In general, there are two aspects of controlling the speed of the karts during a race. First, the kart pit area 80 often has a wire in the floor at the entry and exit points. Karts inside this area are limited to a fairly low, set speed for safety. This speed often is the same as the “Yellow Speed” as described below.

Second, a remote controlled system 60 controls the speed of all the karts simultaneously. It also can control the speed of specific karts. This is done by controlling the speed (i.e., RPM) of the electric motor. The remote control system typically has three speed parameters:

i. Normal Speed (i.e., racing speed)

ii. Yellow Speed (i.e., a slower, safer speed imposed by remote control when necessary for track issues).

iii. Red Speed (i.e., stop).

The maximum speed for a race is generally set according to the race level. More experienced, skilled drivers are permitted to race at higher levels and faster speeds. The remote control system thus can set the “Normal Speed” to be the particular maximum speed for all karts in the race.

However, driver weight can have a significant impact on the acceleration rates and speed of the kart. Two identical karts set to the same maximum speed (e.g., 3000 RPM) will accelerate at different actual rates if the driver weight is different. The kart with a 250 lb. driver will accelerate more slowly than the same kart with a 150 lb. driver.

Accordingly, in one embodiment of the present invention, the motor controller parameters for each kart are adjusted based on driver weight so that the actual speed and acceleration rate of the karts in a race is comparable. In one embodiment, each driver is issued a “Driver's License” in the form of a card with a magnetic stripe that contains, but is not limited to, information on the driver's account balance, driver's race level, and the driver's weight. Other information unrelated to speed control also may be included on the Driver's License card.

Information, including the driver's weight, is read from the Driver's License card and used to adjust the speed of the electric motor of the kart being driven by that participant. The card can be read at the Point-of-Sale (POS) 50 (i.e., cashier, or check-in), or by a card reader 30 on each individual kart. The “Normal Speed” is determined based on race level (e.g., novice, open or pro, although in other embodiments, there may be more than or fewer than three race levels). In one example, the maximum speed levels may be 25 mph for novice, 35 mph for open, and 45 mph for pro. These speeds correlate to a calculated base motor speed necessary to achieve that speed, based upon the typical weight of a kart and an assumed standard driver weight. To achieve these maximum speeds with similar acceleration rates for a particular kart, the electric motor controller 10 adjusts the acceleration rate and/or base motor speed upward or downward, based on the driver's actual weight.

In one embodiment, the point-of-sale (POS) and scheduling software 50 utilize the remote RF system. When a customer checks in they will be assigned to a specific kart that, via the remote RF system, will have that kart electric motor controller programmed to a “Normal Speed” based, at least in part, on the driver's weight. The POS scheduling software also may assign a driver to a proper kart (e.g., one with an appropriate small, medium or large seat) based on weight information.

Alternatively, when the driver chooses or is assigned a particular kart, he or she can insert or swipe their driver's license card in a card reader or similar device on the kart, and the kart's electric motor controller will be programmed based on the driver's race level and weight information contained on the card. This method of programming allows greater flexibility, such as during team driving events.

In an alternative embodiment, the driver's weight information may be stored in a database (as opposed to a Driver's License card), and retrieved by the POS software when the driver checks in.

In yet another embodiment, the system incorporates a timing system 70. The timing system includes a wire placed in the track floor at the finish line that uses the transponder/RF system on each kart to determine the lap time for each kart. The lap time for each kart may be displayed on a public monitor, and also on an optional LED/LCD screen on each kart. In addition, each driver may receive a printout at the end of the race showing their times for each lap. The timing system may integrate with the POS software and necessary equipment to display information on the kart LED/LCD screen. The kart LED/LCD screen may be used to display customer name, lap number, lap time, RPM, or other desired information.

In one embodiment, if the timing system determines that the actual speed of a kart (based on the lap time and lap distance) exceeds the maximum speed allowable for the race, the system can immediately adjust the speed of the electric motor on that kart downwards so the actual speed of the kart is reduced to the maximum speed allowable (or to some lower speed).

In yet another embodiment, the system also can set speed penalties during the race for reckless driving or other infractions of race rules.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A method for adjusting the speed and acceleration rates of an electric go-kart with an electric motor, comprising:
receiving information about the weight of a driver; and
in a computer processor or microprocessor, automatically setting the speed and acceleration rate of the electric motor based at least in part on the weight of the driver.

2. The method of claim 1, wherein the step of setting the speed and acceleration rate of the electric motor also is based on the skill level of the driver.

3. The method of claim 1, wherein the step of setting the speed and acceleration rate of the electric motor also is based on the level of a race in which the go-kart is being driven.

4. The method of claim 1, where the step of receiving information comprises reading the information from a magnetic stripe on a card.

5. The method of claim 4, where the step of receiving information is performed at the kart.

6. The method of claim 4, wherein the step of receiving information is performed remotely from the kart.

7. The method of claim 1, wherein the step of receiving information comprises receiving the information from a computer database.

8. The method of claim 1, further comprising the step of monitoring the lap speed of the go-kart during a race in which the go-kart is driven.

10. An electric go-kart, comprising:
an electric motor;
an electric motor controller; and
a card reader, wherein the electric motor controller adjusts the speed and acceleration rate of the electric motor based upon information received by the card reader.

11. The go-kart of claim 10, wherein the information comprises the weight of a driver of the go-kart.

12. The go-kart of claim 10, wherein the card reader is adapted to receive the information from a card containing the information in a magnetic stripe.

13. A system for electric go-kart racing, comprising:
a track; and
a plurality of electric go-karts to be driven on said track in a race, each kart comprising an electric motor, an electric motor controller, and an RF transponder;
wherein the speed and acceleration rate of the electric motor on each kart is set based at least in part on the level of the race and the weight of the driver in that kart.

14. The system of claim 13, further wherein the driver weight information is contained in a computer database.

15. The system of claim 13, further wherein the driver weight information is contained in a magnetic stripe on a card.

16. The system of claim 15, further comprising one or more card readers adapted to read the driver weight information from the cards.
